(19) United States
(12) Patent Application Publication
(10) Pub. No.: US 2010/0260938 A1
(43) Pub. Date: Oct. 14, 2010

(54) MASK FOR FILM FORMATION AND MASK-AFFIXING METHOD

(75) Inventors: Yoshinari Kondo, Mitsuke-shi (JP); Kentaro Suzuki, Mitsuke-shi (JP); Eichi Matsumoto, Mitsuke-shi (JP); Yoshihiro Kobayashi, Tagawa-gun (JP); Kiichiro Ishikawa, Tagawa-gun (JP)

Correspondence Address: SUGHRUE MION, PLLC, 2100 PENNSYLVANIA AVENUE, N.W., SUITE 800, WASHINGTON, DC, 20037, US

(73) Assignee: TOKKI CORPORATION, Mitsuke-shi, Niigata (JP)

(21) Appl. No.: 12/808,026

(22) PCT Filed: Nov. 14, 2008
(86) PCT No.: PCT/JP2008/070815

§ 371 Date: Jun. 14, 2010

(30) Foreign Application Priority Data
Dec. 13, 2007 (JP) 2007-322422

(51) Int. Cl. B05D 1/32; B05C 21/00

(52) U.S. Cl. 427/282; 118/505

(57) ABSTRACT

A film-formation mask and mask-affixing method with exceptional commercial utility is provided, whereby it is possible to achieve good adhesion to a substrate 6 and to form a film with good film pattern precision. The present invention provides a film-formation mask comprising a mask main body 1 having a pattern of openings through which a film-formation material is allowed to pass, and a holding frame 2 for holding the mask main body 1, a substrate 6 on which the film-formation material is deposited via the pattern of openings being layered on the film-formation mask; the film-formation mask characterized in that the holding frame 2 is provided with a pair of holding parts 4 for holding a pair of side parts 3, respectively, the pair of holding parts 4 being arranged along the pair of opposing side parts on the four sides of the mask main body 1; and the holding frame 2 is configured so that the mask main body 1 is held only by the pair of holding parts 4; the mask main body 1 bends under the weight thereof between the pair of side parts 3 held by the pair of holding parts 4; and the pair of side parts 3 is secured to the pair of holding parts 4 so that the amount bending varies in the opposing direction of the pair of side parts 3.

### TECHNICAL FIELD

The present invention relates to a mask for film formation and a mask-affixing method.

### BACKGROUND ART

In recent years, a so-called four-sided secured soft tension mask has been proposed as a film-formation mask composed of a mask main body having a pattern of openings that admit film formation material, and a holding frame for holding the mask main body, as disclosed in, e.g., Patent Document 1. The four sides of the mask main body 21 are enclosed by the frame 22, and the mask main body 21 is held in place while very light tension or no tension is applied by the frame 22 from four sides, as shown in FIG. 1.

The four-sided secured soft tension mask is advantageous in that it is lightweight and has little temperature variation. Since temperature variation is low, pattern displacement is not liable to occur during deposition performed by a vapor deposition device, and the lightness of weight enables transportation-related costs to be reduced.

[Patent Document 1] Japanese Laid-open Patent Application No. 2007-138256

### DISCLOSURE OF THE INVENTION

### Problems that the Invention is to Solve

However, a problem is presented in that the four-sided secured soft tension mask described above has poor adhesion to the substrate, films formed by, e.g., vapor deposition cannot be formed in accordance with the pattern of openings of the mask main body, and the film-formation pattern on the substrate becomes irregular.

There has also been proposed a configuration in which, for example, a mask main body 31 fashioned in the form of strips is held in a holding frame 32 in a state in which tension is applied from two sides so to avoid bending, as shown in FIG. 2. However, in such a configuration, the center portion 33 of the mask main body 31 warps under the tension, as shown in FIG. 3, and adhesion to the substrate remains poor, making it difficult to adequately form a film.

The present invention is designed to solve the problems described above, and provides a highly practical mask for film formation and a mask-affixing method in which only two opposing sides of the mask main body are secured to holding parts of the holding frame in a state that makes it possible to have the mask main body flex under its own weight so that no nonuniformities will be caused by bending of the mask main body; to achieve good adhesion to the substrate; and to achieve good film pattern precision and good adhesion to the substrate without sacrificing the advantages of lightness of weight and low temperature variability.

### Means of Solving the Problems

The main points of the present invention are described below with reference to the attached drawings.

The present invention according to a first aspect relates to a film-formation mask comprising a mask main body 1 having a pattern of openings through which a film-formation material is allowed to pass, and a holding frame 2 for holding the mask main body 1, a substrate 6 on which the film-formation material is deposited via the pattern of openings being layered on the film-formation mask; the film-formation mask characterized in that the holding frame 2 is provided with a pair of holding parts 4 for holding a pair of side parts 3, respectively, the pair of holding parts 4 being arranged along the pair of opposing side parts 3 on the four sides of the mask main body 1; and is configured so that the mask main body 1 is held only by the pair of holding parts 4; the mask main body 1 bends under the weight thereof between the pair of side parts 3 held by the pair of holding parts 4; and the pair of side parts 3 is secured to the pair of holding parts 4 so that the amount of bending varies in the opposing direction of the pair of side parts 3.

The present invention according to a second aspect relates to the film-formation mask according to the first aspect, characterized in that the pair of side parts 3 of the mask main body 1 are secured to the pair of holding parts 4, respectively, in a state in which the mask main body 1 bends in an unassisted manner under its own weight.

The present invention according to a third aspect relates to the film-formation mask according to the second aspect, characterized in that long members whose length extends along the pair of side parts 3 held by the holding parts 4 are used for the pair of holding parts; and a configuration is employed wherein the pair of side parts 3 can be uniformly secured to the pair of holding parts 4, respectively.

The present invention according to a fourth aspect relates to the film-formation mask according to the second aspect, characterized in that a bend-rectifying body for correcting the bending of the mask main body 1 is disposed on the obverse surface side of the mask main body 1, the obverse surface being on the side opposite the reverse surface side that faces the substrate 6 surface.

The present invention according to a fifth aspect relates to the film-formation mask according to the third aspect, characterized in that a bend-rectifying body for correcting the bending of the mask main body 1 is disposed on the obverse surface side of the mask main body 1, the obverse surface being on the side opposite the reverse surface side that faces the substrate 6 surface.

The present invention according to a sixth aspect relates to the film-formation mask according to the fourth aspect, characterized in that the bend-rectifying body is a rod 7; and the rod 7 is disposed substantially parallel to the pair of side parts 3 secured to the holding parts 4.

The present invention according to a seventh aspect relates to the film-formation mask according to the fifth aspect, characterized in that the bend-rectifying body is a rod 7; and the rod 7 is disposed substantially parallel to the pair of side parts 3 secured to the holding parts 4.

The present invention according to an eighth aspect relates to the film-formation mask according to the sixth aspect, characterized in that the bend-rectifying body is disposed in a position at which the mask main body 1 bends lowest.

The present invention according to a ninth aspect relates to the film-formation mask according to the seventh aspect, characterized in that the bend-rectifying body is disposed in a position at which the mask main body 1 bends lowest.

The present invention according to a tenth aspect relates to a mask-affixing method for causing the film-formation mask according any of aspects 1 through 9 to adhere to a substrate, the mask-affixing method characterized in comprising the steps of layering a substrate 6 on the film-formation mask 5; layering a weight member 8 in the form of a sheet on the substrate 6; and forcibly bending the substrate 6 using the weight member 8 and causing the film-formation mask 5 to adhere to the substrate surface.

The present invention according to an eleventh aspect relates to the mask-affixing method according to the tenth aspect, characterized in that a tungsten sheet is used as the weight member 8.

The present invention according to a twelfth aspect relates to the mask-affixing method according to the eleventh aspect, characterized in that an article made of glass, plastic, or a metal is used as the substrate 6.

### EFFECTS OF THE INVENTION

The present invention as configured above is accordingly film-formation mask and mask-affixing method of high commercial utility, making it possible to eliminate nonuniformities caused by bending of the mask main body, achieve good adhesion to the substrate, and achieve good film pattern precision with good adhesion to the substrate without sacrificing the advantages of lightness of weight and low temperature variability.

### BRIEF DESCRIPTION OF THE DRAWINGS

FIG. 1 is a schematic view of a conventional example;

FIG. 2 is a schematic view of a conventional example;

FIG. 3 is an enlarged schematic cross-sectional view of the main part of FIG. 2;

FIG. 4 is a schematic perspective view of the mask main body of the present embodiment;

FIG. 5 is a schematic perspective view of the present embodiment;

FIG. 6 is a schematic cross-sectional view showing the usage state of the present embodiment; and

FIG. 7 is a schematic cross-sectional view for illustrating the difference in the layering state due to differences in the weight member.

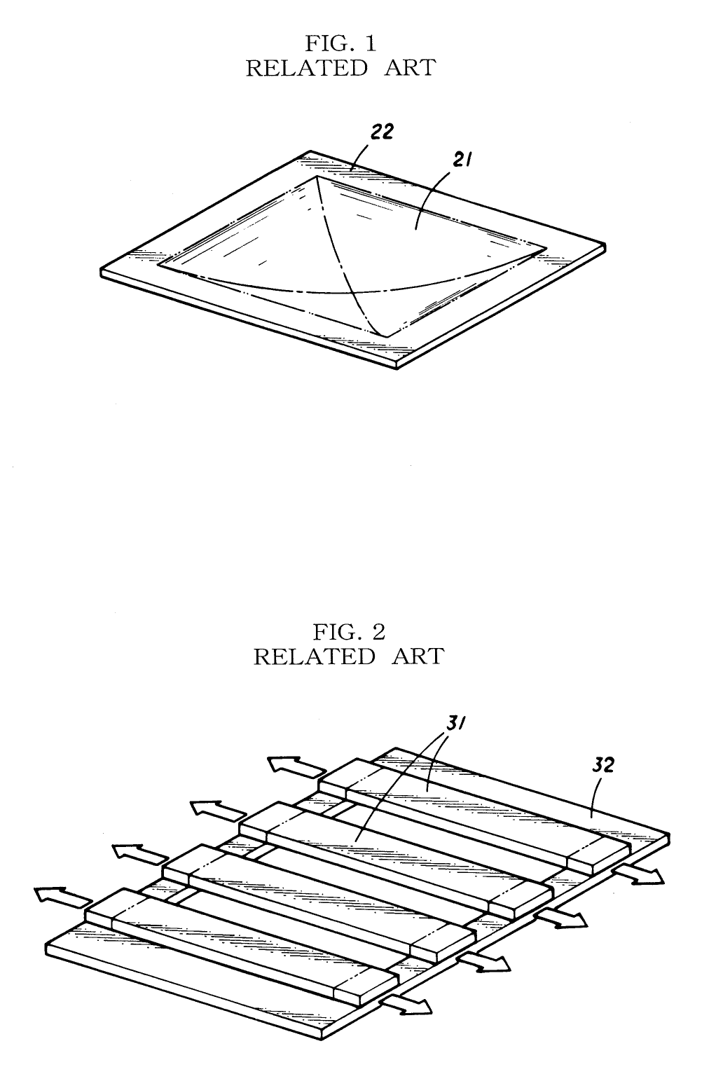

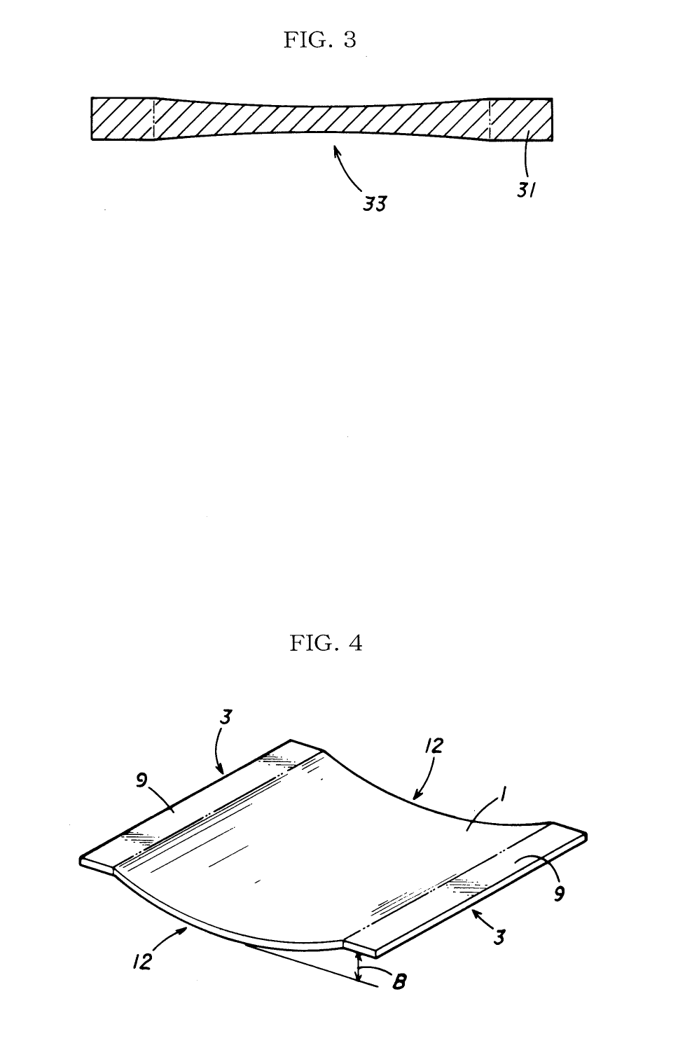

### BEST MODE FOR CARRYING OUT THE INVENTION

Preferred embodiments of the present invention (modes in which the present invention is implemented) are briefly described below with reference to the accompanying drawings while indicating the effects of the present invention.

Two side parts 3 are secured to two holding parts 4, respectively, and a mask main body 1 held in the holding frame 2 bends under its own weight. Therefore, for example, a substrate (and a magnet or the like) is layered thereon in order to carry out film formation, whereupon the mask main body 1 follows the bending of the substrate 6 and the two adhere to each other with good adhesion.

For example, since there is no tension (or very little tension) applied to the four-sided secured soft tension mask, the mask is expected to follow the bending of the substrate and bend and curve to form good adhesion. However, the bending distance in the longitudinal and lateral directions changes when the four sides are secured, and bending in the two directions creates interference that produces nonuniformity in the bending of the mask main body. The mask main body warps, and good adhesion cannot be obtained because the warping produces complications.

In relation to this point, the present invention has a configuration in which a pair of opposing side parts 3 (two sides) is secured to a pair of holding parts 4. The mask main body 1 bends under its own weight between the pair of side parts 3, and the bending distance changes only in the opposing direction (a single direction) of the pair of side parts 3, whereby bending interference does not occur and nonuniformity is less likely to occur. Therefore, warping of the mask main body 1 is simplified and reduced, making it possible for the mask to adequately follow the bending of the substrate 6 and adhere fast thereto.

In other words, since more natural bending can be produced, the mask main body 1 can flexibly follow the bending of the substrate 6 and adhere to the substrate 6 even when the substrate 6 is large and bending is significant. Therefore, when the substrate 6 or the like is laid in place and a film is formed, good adhesion is formed with the substrate 6 and the film can be formed in accordance with the pattern of openings without the film formation pattern being disrupted on the substrate 6.

The strength required in the holding parts 4 can be kept lower than when a certain degree of tension is needed to prevent the mask main body 1 from bending, and the holding frame 2 can be made thinner and more lightweight by a commensurate amount. Therefore, transport and other tasks are facilitated and processability is equivalently improved.

In particular, as the size of the mask (substrate) increases, adhesion declines as a result of the warping of the mask main body 1, and the holding frame 2 becomes thicker and heavier. However, in accordance with the present invention, thickness and weight are reduced and good adhesion with the substrate can be achieved even when a large mask is used.

For example, if the bending of the mask main body 1 is corrected when a rod 7 that is substantially parallel to the pair of side parts 3 secured to the pair of holding parts 4 is disposed on the surface of the mask main body 1 that is obverse with respect to the reverse surface that faces the surface of the substrate 6, the mask main body 1 can be allowed to bend uniformly, it will be possible to eliminate any difference in bending distance between the region in which the pattern of openings of the mask main body 1 is formed and the region other than that of the pattern of openings, and adhesion with the substrate 6 will be further improved. In particular, the rod 7 is disposed on the mask main body 1 to provide a lowest position of bending, thereby making it possible to adequately eliminate the difference in bending distances.

With a film-formation mask 5 such that described above, for example, the substrate 6 is layered on the film-formation mask 5, a weight member 8 in the form of a sheet is layered on the substrate 6, and the substrate 6 is forcibly made to bend by the weight member 8, whereby good adhesion with the substrate surface can be achieved. In such instances, using a flexible and heavy tungsten sheet as the weight member 8 makes it possible to cause the substrate 6 to bend further in a favorable manner and to adhere to the mask main body.

### EXAMPLES

Specific examples of the present invention are described below with reference to FIGS. 4 to 7.

The present example is a film-formation mask on which a substrate 6 is layered, the film-formation mask being composed of a mask main body 1 having a pattern of openings for admitting film formation material to pass and a holding frame 2 for holding a mask main body 1, and the film formation material being deposited on the substrate 6 via the pattern of openings, as shown in FIGS. 4 and 5. The holding frame 2 is provided with two holding parts 4 for holding two side parts 3, respectively, the pair of holding parts 4 being arranged along the pair of opposing side parts 3 among the four sides of the mask main body 1, and configured so that the mask main body 1 is held only by the pair of holding parts 4, the mask main body 1 bends under its own weight between the pair of side parts 3 held by the pair of holding parts 4, and the pair of side parts 3 is secured to the pair of holding parts 4 so that the bending distance varies in the opposing direction of the pair of side parts 3.

Each of the parts will now be described in detail.

The mask main body 1 is a common quadrangular metal mask made of Invar or another metallic material. The mask main body 1 has a film-formation region and a non-film-formation region. The film-formation region is formed from a pattern of openings (not shown) and a frame portion other than the pattern of openings, and is arranged in the region through which the film formation material passes inside the film formation device. The non-film-formation region is provided on the outer side (external periphery) of the film-formation region.

Specifically, edge parts 9 that serve as the non-film-formation regions are provided to the left and right of the film-formation region, and the edge parts 9 are secured to the pair of holding parts 4 of the holding frame 2. The edge parts 9 may be provided in continuous fashion to the long or short sides of the film-formation region of the mask main body 1.

The holding frame 2 is a frame body composed of Invar or another metallic material. In the present embodiment, a pair of opposing side parts 10 that face the frame body is provided to the pair of holding parts 4. A pair of opposing side parts 11 other than the holding parts is arranged so as to not be in contact with another pair of side parts 12 (not held by the holding parts 4) of the mask main body 1. The opposing side parts 10 and the opposing side parts 11 are provided in continuous fashion by way of corner sections.

The holding frame 2 is configured so that the aperture potion is larger than at least the film-formation region of the mask main body 1 so as avoid overlapping the film-formation region of the mask main body 1, and is also configured so that the edge parts 9 of the mask main body 1 are secured to the pair of opposing side parts 10 serving as the pair of holding parts 4.

In the present embodiment, the pair of side parts 3 of the mask main body 1 is secured to the pair of holding parts 4 of the holding frame 2 so that tension is not applied to the mask main body 1, and the mask main body 1 bends in an unassisted manner under its own weight.

Specifically, one side of the left and right edge parts 9 is secured to one of the holding parts 4 based on the natural maximum bending distance B in a state in which the mask main body 1 is substantially parallel to but not secured to the holding parts 4. The securing position on the other side is suitably adjusted and set with the other edge part secured to the other holding part 4, so that the securing position on the other side is not too near the first securing position, which would result in a forcibly recessed curve, nor too far, which would result in tension (i.e., so that there is no warping in the center portion).

The pair of side parts 3 (edge parts 9) and the holding parts 4 (opposing side parts 10) of the mask main body 1 are securely bonded using an adhesive.

Specifically, the pair of opposing side parts 10 of the frame body are in contact with the entire length of the edge parts 9 of the mask main body 1, and the lower surface of the edge parts 9 of the mask main body 1 and the upper surface of the opposing side parts 10 of the frame body are secured in a substantially uniform manner by the adhesive across substantially the entire region in the lengthwise direction.

The lower surface of the edge parts 9 and the upper surface of the opposing side parts 10 may be bonded over the entire surface or only on a portion of the surface. In the present example, the edge parts 9 and the pair of holding parts 4 are bonded in a substantially uniform manner across substantially the entire region in the lengthwise direction, but the bonding may be located at predetermined intervals (numerous bonding portions may be provided in intervals). Although an adhesive is used for bonding, no limitation is imposed thereby; the pair of side parts 3 of the mask main body 1 may be welded or otherwise secured to the holding parts 4 of the mask main body 1.

Since the pair of side parts 3 are secured to the pair of holding parts 4 so that tension (tensile force and pressing force) is not applied to the mask main body 1, i.e., in a state in which no tension is present, the mask main body 1 bends in an unassisted manner in a curved arcuate shape under its own weight between the pair of side parts 3 (edge parts 9), and the bending distance varies in the opposing direction of the pair of side parts 3. Therefore, in the present example, the position equidistant from the pair of side parts 3 becomes the lowest bending point position, and the maximum bending distance is increased.

The bending distance B is shown in an exaggerated manner for illustrative purpose in the drawings, but the distance is very small in reality and is ordinarily about several ten to several hundred microns for a mask main body 1 having a thickness of several millimeters. The thickness of the holding frame 2 is also shown in an exaggerated manner in accordance with the bending distance B, but the thickness is actually about several millimeters.

In the present example, a rod 7 substantially parallel to the pair of side parts 3 secured to the pair of holding parts 4 is disposed on the obverse surface side of the mask main body 1, which is the side opposite from the reverse surface side for adhering to substrate surface, so as to correct the bending of the mask main body 1.

Specifically, the rod 7 is made of Invar or another metal material in the same manner as the holding frame 2, and a single rod is disposed in the lowest position at which the mask main body 1 bends (the position at the maximum bending distance).

This is because the bending of the mask main body 1 becomes nonuniform in the direction parallel to the edge parts 9 of the mask main body 1, and the nonuniformity of the bending is corrected by using a weight member to pull on the portions in which the bending distance is small in a range that does not interfere with natural bending. The rod 7 further improves adhesiveness between the mask main body 1 and the surface of the substrate. In other words, the configuration of the present example is designed so that the bending distance varies only in the opposing direction of the pair of side parts 3, and the bending distance does not vary in the parallel direction.

In the present example, a single rod 7 is disposed at the lowest position of bending of the mask main body 1, but the lowest position is not given by way of limitation; the rod may be disposed in another location or in a plurality of locations. Also, the bending shape of the mask main body 1 made by the rod 7 is not limited to a curved arcuate shape; the deformation may be a waveform or another shape. The rod 7 may be provided in the opposing direction of the pair of side parts 3 secured to the pair of holding parts 4. Furthermore, in the example described above, the rod 7 is provided as a specific example of the bend-rectifying body, but no limitation is imposed thereby; a plate shape or a mesh shape may be used. However, the bend-rectifying body must be provided to the frame portion in a manner that avoids blocking at least the pattern of openings and avoids interference with film formation.

In the present example, the mask main body 1 is secured to the pair of holding parts 4 without the application of tension, but a small amount of tension may be applied (a so-called soft tension mask may be used).

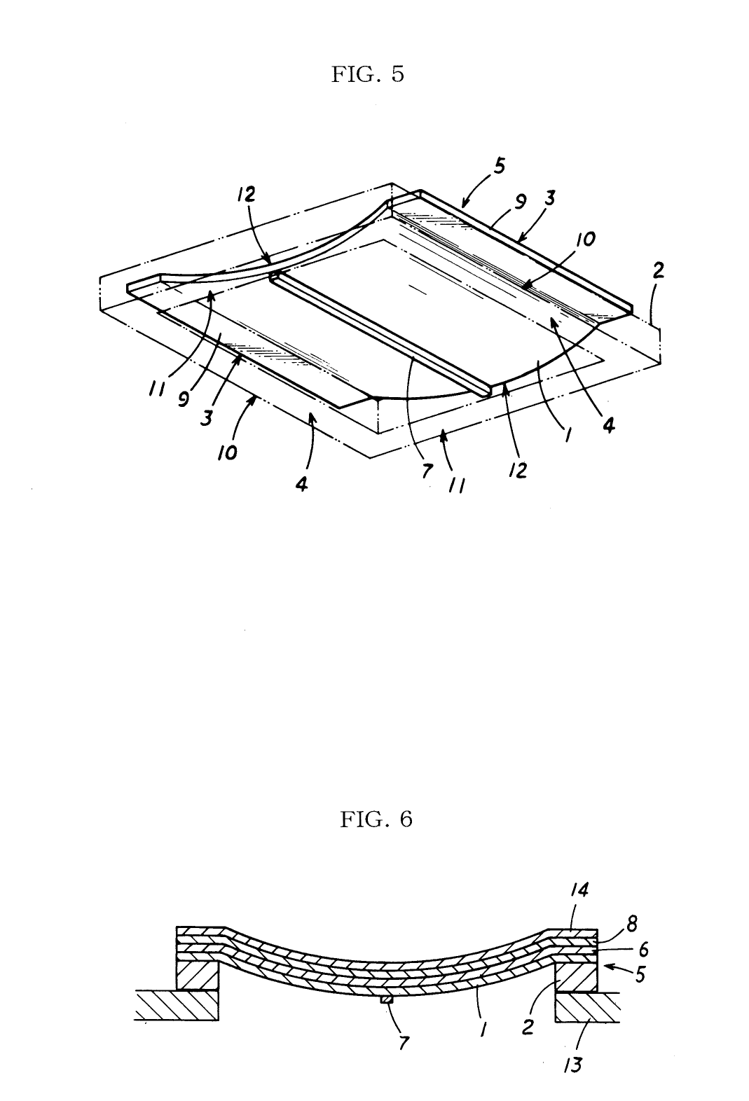

The film-formation mask 5 related to the present example is used for forming a film on a glass substrate 6 by, e.g., placing the film-formation mask on a holding mechanism 13 of the film formation device, layering the glass substrate 6 on the film-formation mask 5, layering a flexible weight member 8 in form of a sheet on the glass substrate 6, causing the film-formation mask 5 to adhere to the substrate surface by using the weight member 8 to forcibly bend the glass substrate 6, additionally layering a magnet 14 that is capable of magnetically attracting and drawing the mask main body 1 to the substrate side, causing the film-formation mask 5 and the glass substrate 6 to adhere together using the magnet 14 (see FIG. 6), and spraying a film-formation material from below using vapor deposition, CVD, sputtering, or other film formation means.

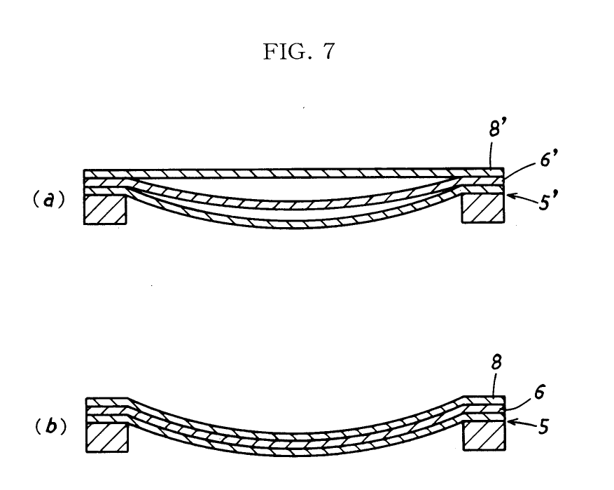

The weight member 8 is preferably a flexible member having a certain amount of weight. Specifically, a tungsten sheet composed of tungsten and an elastomer is advantageous. If a tungsten sheet is used, the tungsten sheet causes the substrate 6 to curve together with the curvature of the tungsten sheet and press against the mask main body 1 to form good adhesion with the mask main body 1 (see FIG. 7(b)).

If a weight member 8′ composed of, e.g., aluminum, glass, or another hard substance is used, the weight member will not adequately bend, as shown in FIG. 7(a), the substrate 6′ cannot be made to bend, and the adhesiveness between the substrate 6′ and the film-formation mask 5′ will be inadequate. The weight member 8 is not limited to a tungsten sheet; it is also possible to use fluororubber or a silicon sheet.

The use of a rubber magnet as the magnet 14 is advantageous in that each of the film-formation mask 5, the substrate 6, the weight member 8, and the magnet 14 bends and adheres with advantageous effect.

The substrate 6 is not limited to being a glass substrate 6; it is also possible to advantageously form a film in a similar fashion when the substrate is made of a plastic, metal (foil) or other material.

Since the present example is configured in the manner described above, the two side parts 3 are secured to the two holding parts 4, respectively, and the mask main body 1 held by the holding frame 2 bends under its own weight. Therefore, the bending of the mask main body 1 follows that of the substrate 6 and the two have good adhesion when, for example, the substrate 6 (and magnet or the like) is layered in order to form a film.

For example, with a four-sided secured soft tension mask, no tension (or very little tension) is applied, so the mask will presumably follow the bending of the substrate and then bend, curve, and achieve good adhesion; however, the bending distance in two directions, i.e., in the longitudinal and lateral directions, changes when the four sides are secured, and bending in the two directions creates interference that produces nonuniformity in the bending of the mask main body. The mask main body warps and good adhesion cannot be obtained because the warping produces complications.

The present example is configured so that the pair of opposing side parts 3 (two sides) are secured to the pair of holding parts 4. The mask main body 1 can adequately follow the bending of the substrate 6 and achieve good adhesion because the mask main body 1 bends in an arcuate fashion under its own weight between the pair of side parts 3, and the bending distance only varies in the opposing direction (single direction) of the pair of side parts 3. Nonuniformity is thus not liable to occur because there is no bending interference; therefore, the warping of the mask main body 1 is simplified and reduced.

In other words, since the mask main body 1 can bend more naturally, it can flexibly follow the bending of the substrate 6 and achieve good adhesion even when the substrate 6 is large and bending is more pronounced. Therefore, when a substrate 6 or the like is layered and a film is formed, the film can be formed according to the pattern of openings without the film formation pattern becoming disrupted on the substrate 6.

The strength required in the holding parts 4 can be kept lower than when a certain amount of tension needs to be maintained to prevent the mask main body 1 from bending, and the holding frame 2 can be made thinner and more lightweight by a commensurate amount. Therefore, transport and other tasks are facilitated and processability is equivalently improved.

In particular, as the size of the mask (substrate) increases, adhesiveness decreases more dramatically due to the warping of the mask main body 1, and the holding frame 2 becomes thicker and heavier. However, in accordance with the present invention, thickness and weight are reduced and good adhesion with the substrate can be achieved even when a large mask is used.

The bending of the mask main body 1 is corrected and the mask main body 1 is therefore made to uniformly bend when a rod that is substantially parallel to the pair of side parts 3 secured to the pair of holding parts 4 is disposed on the obverse surface side of the mask main body 1, which is the side opposite from the reverse surface side that faces the surface of the substrate. It is possible to eliminate the difference in bending distance between the region in which the pattern of openings of the mask main body 1 is formed and the region other than that of the pattern of openings, and adhesion with the substrate 6 is further improved. In particular, the rod 7 is disposed on the mask main body 1 to provide a lowest position of bending, thereby making it possible to more adequately eliminate the difference in bending distances.

Therefore, the present example is very practical in that a film can, in accordance with a pattern of openings, be advantageously formed on the substrate with good adhesion and without the vapor deposition pattern being disrupted on the substrate. This makes it possible to eliminate nonuniformity caused by the bending the mask main body and to achieve good adhesion with respect to the substrate without compromising the advantages of lightness of weight and low temperature variability.

The present invention is not limited to the present example; the specific configuration can be suitably designed in accordance with various structural requirements.

1-12. (canceled)

13. A film-formation mask comprising a mask main body having a pattern of openings through which a film-formation material is allowed to pass, and a holding frame for holding the mask main body, a substrate on which said film-formation material is deposited via said pattern of openings being layered on the film-formation mask; said film-formation mask characterized in that said holding frame is provided with a pair of holding parts for holding a pair of side parts, respectively, the pair of holding parts being arranged along the pair of opposing side parts on the four sides of said mask main body; and is configured so that said mask main body is held only by the pair of holding parts, said mask main body bends under the weight thereof between said pair of side parts held by said pair of holding parts, and the pair of side parts can be secured to said pair of holding parts so that an amount of said bending varies in the opposing direction of the pair of side parts; and
long members whose length extends along said pair of side parts held by the holding parts are used for said pair of holding parts; and a configuration is employed wherein the pair of side parts can be uniformly secured to said pair of holding parts, respectively.

14. The film-formation mask according to claim 13, characterized in that said pair of side parts of said mask main body are secured to said pair of holding parts, respectively, in a state in which the mask main body bends in an unassisted manner under the weight thereof.

15. The film-formation mask according to claim 13, characterized in that a bend-rectifying body for rectifying the bending of said mask main body is disposed on the obverse surface side of said mask main body, the obverse surface being on the side opposite the reverse surface side that faces the substrate surface.

16. The film-formation mask according to claim 14, characterized in that a bend-rectifying body for rectifying the bending of the mask main body is disposed on the obverse surface side of said mask main body, the obverse surface being on the side opposite the reverse surface side that faces the substrate surface.

17. The film-formation mask according to claim 15, characterized in that said bend-rectifying body is a rod; and the rod is disposed substantially parallel to the pair of side parts secured to said holding parts.

18. The film-formation mask according to claim 16, characterized in that said bend-rectifying body is a rod; and the rod is disposed substantially parallel to the pair of side parts secured to said holding parts.

19. The film-formation mask according to claim 17, characterized in that said bend-rectifying body is disposed in a position at which the mask main body bends lowest.

20. The film-formation mask according to claim 18, characterized in that said bend-rectifying body is disposed in a position at which the mask main body bends lowest.

21. A mask-affixing method for causing the film-formation mask according claim 13 to adhere to a substrate, said mask-affixing method characterized in comprising the steps of layering a substrate on said film-formation mask; layering a weight member in the form of a sheet on the substrate; and forcibly bending the substrate using the weight of the weight member and causing said film-formation mask to adhere to the substrate surface.

22. The mask-affixing method according to claim 21, characterized in that a tungsten sheet is used as said weight member.

23. The mask-affixing method according to claim 22, characterized in that an article made of glass, plastic, or metal is used as said substrate.
